(19) United States
(12) Patent Application Publication
(10) Pub. No.: US 2014/0365273 A1
(43) Pub. Date: Dec. 11, 2014

(54) Data analytics collection for customer interaction with products in a retail store

(71) Applicant: Matthew Hurewitz, Hemet, CA (US)

(72) Inventor: Matthew Hurewitz, Hemet, CA (US)

(73) Assignee: BBY SOLUTIONS, INC., Richfield, MN (US)

(21) Appl. No.: 13/961,140

(22) Filed: Aug. 7, 2013

Related U.S. Application Data
(63) Continuation of application No. 13/912,784, filed on Jun. 7, 2013.

(51) Int. Cl. G06Q 30/02

(52) U.S. Cl. CPC G06Q 30/0201
USPC 705/7.29

(57) ABSTRACT

A system and method for data analytics includes a physical retail store having a plurality of sensors provided in various locations around the physical store. The sensors may include motion sensors, visual imaging cameras, heat sensors, or other kinds of sensors. Information about the customer's shopping behavior is collected by detecting the customer at a first sensor and monitoring the customer's motion as the customer moves out of the sensing range of the first sensor and into the sensing range of other sensors around the store. The system may track the customer anonymously. In one embodiment, the customer self-identifies in the store, for example when making a purchase. If the customer chooses to self-identify, the previously anonymous shopping behavior for that customer can be associated with the customer's unique ID. Based on the shopping behavior, the retailer can provide the customer with deals and customized content.

### CROSS-REFERENCE TO RELATED APPLICATIONS

This application is a continuation of U.S. patent application Ser. No. 13/912,784, filed Jun. 7, 2013 and entitled “Retail Store Customer Natural-Gesture Interaction With Animated 3D Images Using Sensor Array,” the entirety of which is herein incorporated by reference. This application is a continuation-in-part of U.S. patent application Ser. No. 13/912,811, filed Jun. 7, 2013 and entitled “Data Analytics Collection For Customer Interaction With Products In A Retail Store,” the entirety of which is herein incorporated by reference.

### FIELD OF THE INVENTION

The present application relates to the field of interactive virtual retail displays. More particularly, the described embodiments relate to a retail store virtual product display allowing customers to interact with three-dimensional rendered virtual images of products.

### BACKGROUND

Consumer retailer sellers with brick-and-mortar physical retail stores are increasingly at a disadvantage in the retail business because of the high cost of operating a physical store over maintaining an online business. It would be desirable for a retailer with a physical store to decrease the amount of physical product inventory in a physical store while still offering a large number of products for sale.

### SUMMARY

One embodiment of the present invention provides an improved system for selling retail products in a physical retail store. The system replaces some physical products in the retail store with three-dimensional (3D) rendered images of the products for sale. The described system and methods allow a retailer to offer a large number of products for sale without requiring the retailer to increase the amount of retail floor space devoted to physical products.

### BRIEF DESCRIPTION OF THE DRAWINGS

FIG. 1 is a schematic diagram of a physical retail store of the present disclosure.

FIG. 2 is a schematic diagram of a system for providing a virtual interactive product display.

FIG. 3 is a schematic diagram of a controller computer for a virtual interactive product display.

FIG. 4 is a schematic of a product record in a product database.

FIG. 5 is a schematic diagram of a data analysis server.

FIG. 6 is a diagram of a user record in a user information database.

FIG. 7 is a schematic diagram of a mobile device for use with a virtual interactive product display.

FIG. 8 is a perspective view of retail store customers interacting with a virtual interactive product display.

FIG. 9 is a diagrammatic view of a mobile device controlling a virtual interactive product display with side-by-side function.

FIG. 10 is a second embodiment of a mobile device controlling a virtual interactive product display.

FIG. 11 is a flow chart demonstrating a method for presenting products to retail customers in a physical retail store.

FIG. 12 is a flow chart demonstrating a method for using a virtual interactive product display to analyze customer emotional reaction to retail products for sale.

FIG. 13 is a flow chart demonstrating a method for displaying pre-selected product images on a virtual interactive product display.

FIG. 14 is a flow chart demonstrating a method for analyzing shopping data for self-identified retail store customers.

FIG. 15 is a flow chart demonstrating a method for presenting side-by-side product comparisons using a virtual interactive product display.

FIG. 16 is a flow chart demonstrating a method for searching and displaying three-dimensional rendered models of products for sale.

FIG. 17 is a flow chart demonstrating a combination of methods for a virtual interactive product display.

FIG. 18 is a schematic diagram of a physical retail store system for analyzing customer shopping patterns.

FIG. 19 is a flow chart demonstrating a method for collecting customer data analytics.

### DETAILED DESCRIPTION

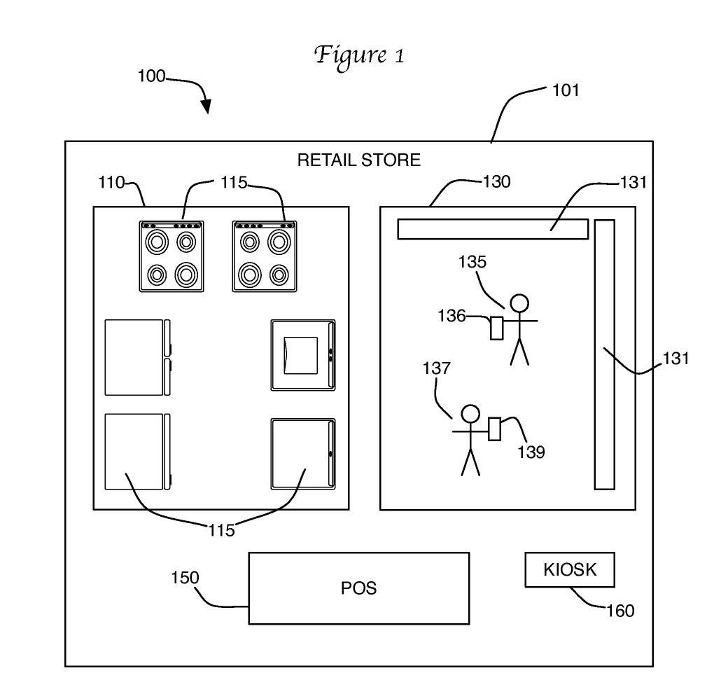

FIG. 1 shows a retail store system 100 including a retail space 101 having both physical retail products 115 and a virtual interactive product display 131 that allows customers to virtually interact with three-dimensional (3D) rendered images of products for sale. The virtual display 131 allows a retailer to present an increased assortment of products for sale without increasing the footprint of retail space 101. The display 131 could be implemented in a number of different ways.

A first floor-space 110 within retail store 101 holds a plurality of physical retail products 115 for sale. A second floor-space 130 is dedicated to the virtual display 131. The retail space 101 could have more than one virtual display 131 in floor-space 130. The system 100 may be used in retail spaces 101 containing consumer products 115 that occupy a large physical area.

In one embodiment the display 131 could be a single 2D- or 3D-TV television screen. However, in a preferred embodiment the display 131 would be implemented as a large-screen display that could, for example, be projected onto an entire wall by a video projector. The display 131 could be a wrap-around screen surrounding a customer 135 on more than one side. The display 131 could also be implemented as a walk-in virtual experience with screens on three sides of the customer 135. The floor of space 130 could also have a display screen, or a video image could be projected onto the floor-space 130.

The display 131 preferably is able to distinguish between multiple users. For a large display screen 131, it is desirable that more than one product could be displayed, and more than one user at a time could interact with the display 131. In one embodiment of a walk-in display 131, 3D sensors would distinguish between multiple users. The users would each be able to manipulate virtual interactive images independently.

In one embodiment the retail products 115 may be consumer appliances such as refrigerators, washing machines, dryers, dishwashers, and ovens. The system 100 could also be used with products such as consumer electronics, furniture, sports equipment, automotive products, and many other types of retail products.

A point-of-sale (POS) 150 within retail store 101 allows customers 135 to purchase physical retail products 115 or order products that the customer 135 viewed on the virtual display 131. A sales clerk 137 may help customer 135 with purchasing products 115 and products displayed on the virtual display 131. Customer 135 and sales clerk 137 may have mobile devices 136 and 139 for selecting products to view on display 131. The mobile devices 136, 139 may be tablet computers, smartphones, portable media players, laptop computers, or wearable “smart” fashion accessories such as watches or eyeglasses. In one embodiment the device 139 may be a dedicated device for use only with the display 131.

A kiosk 160 could be provided to help customer 135 search for products to view on virtual display 131. The kiosk 160 may have a touchscreen user interface that allows customer 135 to select several different products to view on display 131. Products could be displayed one at a time or side-by-side. The kiosk 160 could also be used to create a queue or waitlist if the display 131 is currently in use.

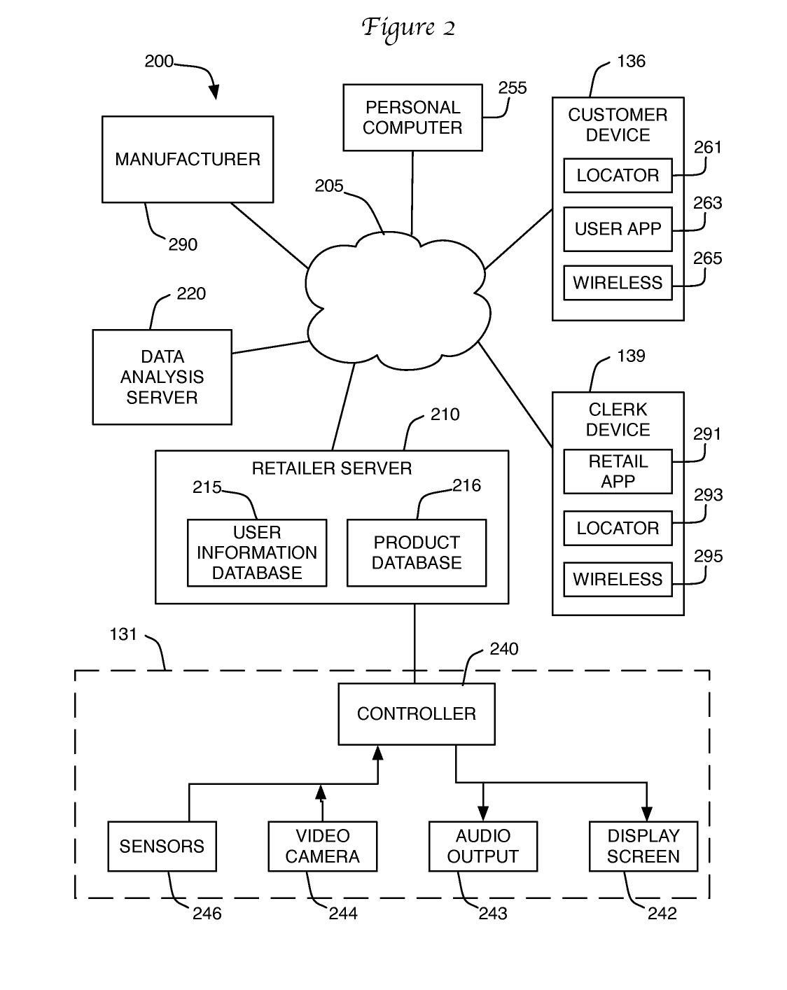

FIG. 2 shows an information system 200 for implementing an interactive virtual product display 131 in a retail store system 100. The various components in the system 200 are connected to a data network 205 such as the Internet. It is to be understood that the architecture of system 200 as shown in FIG. 2 is an exemplary embodiment, and the system architecture could be implemented in many different ways.

A retailer server 210 is accessible via network 205. The server 210 has access to a user information database 215 and a 3D model product database 216. The user database 215 contains information about customers who shop and purchase products in the retail store 101. In one embodiment customers are assigned a unique identifier (“user ID”) linked to personally-identifying information and purchase history for that customer. The user ID may be linked to a user account, such as a credit line or store shopping rewards account. In a preferred embodiment the user is encouraged to self-identify on a retailer website, a mobile app, and in a physical retail store.

Product database 216 contains 3D rendered images of products for sale by the retailer. The plurality of images in database 216 are linked to product information for a plurality of products represented by the images. Product information may include product name, manufacturer, category, description, price, and an identifier (“product ID”) for each product. The database 216 is searchable by customer device 136 and clerk device 139. The database 216 may also be searchable through an Internet browser on a personal computer 255.

As shown in FIG. 2, the display 131 includes a display screen 242, audio speaker output 243, a video camera 244, and one or more sensors 246. Sensors 246 could include motion sensors, 3D depth sensors, heat sensors, light sensors, audio microphones, etc. The camera 244 and sensors 246 provide a mechanism by which a customer 135 can interact with virtual 3D product images on display screen 242 using natural gesture interactions.

A “gesture” may be a command for a computer to perform an action. In the system 200, sensors 246 and camera 244 capture raw sensor data of motion, heat, light, or sound, etc. created by a customer 135 or clerk 137. The raw sensor data is analyzed and interpreted by a computer. A gesture may be defined as one or more raw data points being tracked between one or more locations in one-, two-, or three-dimensional space (e.g., in the (x, y, z) axes) over a period of time. As used herein, a “gesture” could also include an audio capture such as a voice command, or a data input received by sensors, such as facial recognition. Many different types of natural-gesture computer interactions will be known to one of ordinary skill in the art. For example, such gesture interactions are described in U.S. Pat. No. 8,213,680 (Proxy training data for human body tracking) and U.S. patent application publications US 20120117514 A1 (Three-Dimensional User Interaction) and US 20120214594 A1 (Motion recognition), all assigned to Microsoft Corporation, Redmond, Wash.

A controller computer 240 receives gesture data from the camera 244 and sensors 246 and sends the received gesture data to a data analysis server 220. The controller 240 also receives 3D image information from the product database 216 and sends the information to be output on display screen 242. The controller 240 is accessible by the retailer server 210. In the embodiment shown in FIG. 2, the controller 240 is accessible via the retailer server. In an alternative embodiment the controller 240 could be directly connected to and accessible via data network 205.

As shown in FIG. 2, customer mobile device 136 and sales clerk mobile device 139 each contain software applications or “apps” 263, 291 to search the product database 216 for products viewable on the interactive display 131. In one embodiment, a user may be able to search for products directly through the interface of interactive display 131. However, it would be advantageous to allow the customer 135 to choose products to view before the customer 135 enters the retail store 101. It would also be advantageous for a store clerk 137 to be able to assist the customer 135 to choose which products to view on the display 131. User app 263 and retailer app 291 allow for increased efficiency in the system 200 by providing a way for customers 135 to pre-select products to view on display 131.

In addition to the apps 263 and 291, devices 136 and 139 of FIG. 2 include wireless communication interfaces 265, 295. The wireless interfaces 265, 295 may communicate via one or more wireless protocols, such as Wi-Fi, cellular data transfer, Bluetooth, infrared, radio frequency, near-field communication (NFC) or other wireless protocols. The wireless interfaces 265, 295 allow the devices 136, 139 to search the product database 216 remotely through network 205. The devices 136, 139 may also send requests to controller computer 310 to display images on display 131.

Devices 136, 139 also preferably include a geographic location indicator 261, 293. The location indicators 261, 293 may be use global positioning system (GPS) tracking, but the indicators 261, 293 may use other methods of determining a location of the devices 136, 139. For example, the device location could be determined by triangulating location via cellular phone towers or Wi-Fi hubs. In an alternative embodiment, locators 261, 293 could be omitted. In this embodiment the system 200 could identify the location of the devices 136, 139 by detecting the presence of wireless signals from wireless interfaces 265, 295 within retail store 101.

In one embodiment, customer 135 and clerk 137 can select pre-select a plurality of products to view on an interactive display 131 in a physical retail store 101. The pre-selected products may be a combination of both physical products 115 and products having 3D rendered images in database 215. In a preferred embodiment the customer 135 must self-identify in order to save pre-selected products to view at the interactive display 131. The method could also be performed by an anonymous customer 135.

If the product selection is made at a customer mobile device 136, the customer 135 does not need to be within the retail store 101 to choose the products. The method can be performed at any location because the selection is stored on a physical memory, either in a memory on customer device 136, or on a remote memory available via network 205, or both. The product selection may be stored in user information database 215 along with identifying information for customer 135.

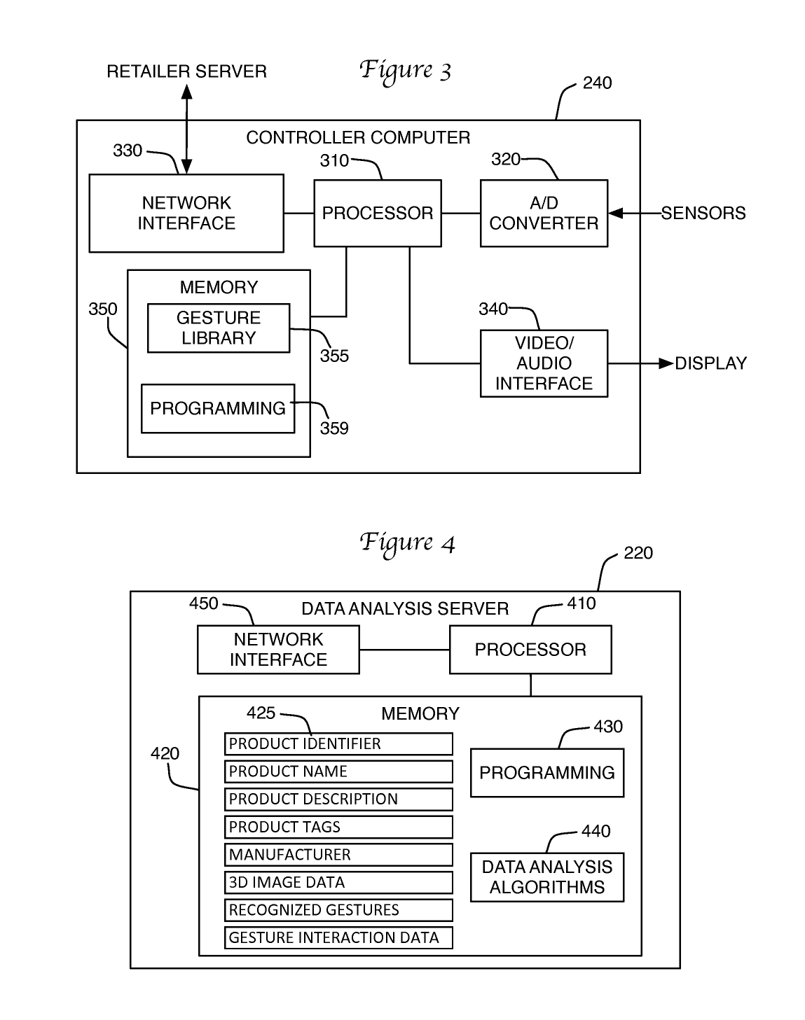

FIG. 3 is a schematic diagram of controller computer 240. The controller 240 includes a computer processor 310 accessing a memory 350. In one embodiment the memory 350 stores a gesture library 355 and programming 359 to control the functions of display 131. An A/D converter 320 receives sensor data from sensors 246, 244 and relays the data to processor 310. Controller 240 also includes an video/audio interface to send video and audio output to display screen 242 and audio output 243. Processor 310 may encompass a specialized graphics processing unit (GPU) to handle the processing of the 3D rendered images to be output to display screen 242. A communication interface 330 allows controller 240 to communicate via the network 205. Interface 330 may also include an interface to communicate locally with devices 136, 139, for example through a Wi-Fi, Bluetooth, RFID, or NFC connection, etc.

In one embodiment, the customer 135 has a customer mobile device 136 having a software application program 263, a wireless interface 265, and a device locator 261. The app 263 may be a retailer-branded software app that allows the customer 135 to self-identify within the app 263. The customer 135 may self-identify by entering a unique identifier into the app 263. The user identifier may be a loyalty program number for the customer 135, a credit card number, a phone number, an email address, a social media username, or other such unique identifier that uniquely identifies a particular customer 135 within the system 200. The identifier is preferably stored in user information database 215 as well as in a physical memory of device 136.

The app 263 may allow the customer 135 to choose not to self-identify. Anonymous users could be given the ability to search and browse products for sale within app 263. However, far fewer app features would be available to customers 135 who do not self-identify. For example, self-identifying customers would able to make purchases via device 136, create “wish lists” or shopping lists, select communications preferences, write product reviews, receive personalized content, view purchase history, or interact with social media via app 263. Such benefits may not be available to customers who choose to remain anonymous.

FIG. 4 is a schematic diagram of data analysis server 220. Server 220 has a processor 410 and a network interface 450 to access the network 205. The server 220 is used to analyze gesture data for customer 135 interaction with 3D rendered images at display 131. In the embodiment shown in FIG. 4, the data analysis server 220 receives data from the controller 240 and the product database 216 and stores the data as data analysis records 425 on a memory 420. Each product in database 216 preferably has a data record 425 on the server 220. The data records 425 are analyzed using programming 430 and data analysis algorithms 440. In an alternative embodiment the data analysis records may be stored on a database accessible via network 205 instead of in memory 420.

In one embodiment, gesture data captured by controller 240 is sent to data analysis server 220, where the gesture data is analyzed and used to provide product feedback related to how customers 135 interact with the 3D rendered images. For example, the server 220 may aggregate a “heat map” of gesture interactions by customers 135 with 3D images on product display 131. A heat map visually depicts the amount of time a user spends interacting with various features of the 3D image. The heat map may use head tracking, eye tracking, or hand tracking to determine which part of the 3D rendered image the customer 135 interacted with the most or least. In another embodiment, the data analysis may include analysis of the user's posture or facial expressions to infer the emotions that the user experienced when interacting with certain parts of the 3D rendered images. The retailer may aggregate analyzed data from the data analysis server and send the data to a manufacturer 290. The manufacturer 290 can then use the data to improve the design of future consumer products.

The gesture data captured by controller 240 may also include aggregation of demographic data of customers 135. Demographics such as age and gender can be identified using the sensors of interactive display 131. These demographics can also be used in the data analysis to improve product design.

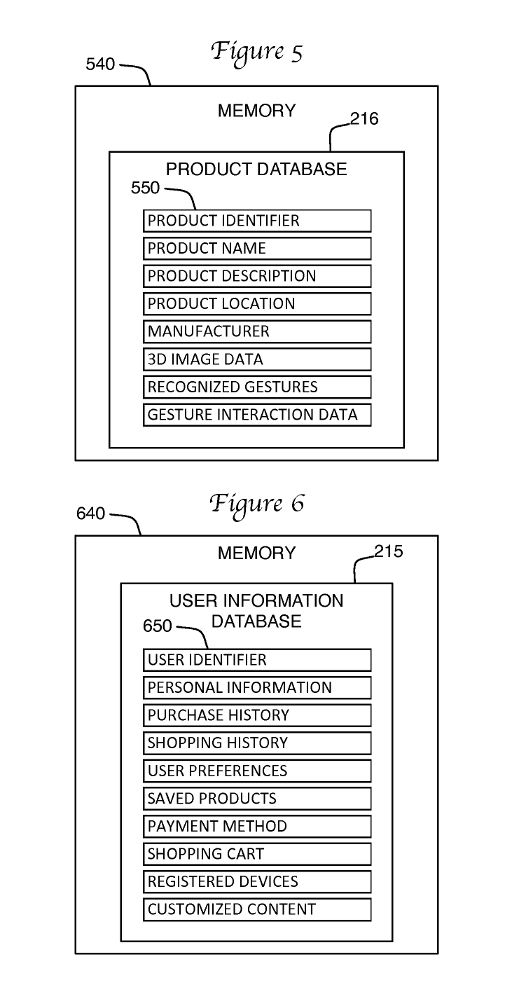

FIG. 5 shows an exemplary embodiment of the product database 216. The database 216 resides on a memory 540 and contains product data records 550. Data 550 includes 3D rendered images of products for sale. Each product and image in the database record 550 may include a product identifier, product name, product description, product location such as a store location that has the physical product in-stock, a product manufacturer, and gestures that are recognized for the particular 3D image associated with the data record 550. The product location data may indicate that the particular product is not available in a physical store, and only available to view as an image on a virtual interactive display. Other information associated with products for sale could be included in product records 550, and will be evident to one skilled in the art.

FIG. 6 shows an exemplary embodiment of the user information database 215. The database 215 resides on a memory 640 and contains user records 650 containing information about customers 135. User records 650 may include a user ID, personal information such as name and address, purchase history, shopping history, user preferences, saved product lists, a payment method uniquely associated with the customer such as a credit card number or store charge account number, a shopping cart, registered mobile device(s) associated with the customer 135, and customized content for that user, such as deals, coupons, recommended products, and other content customized based on the user's previous shopping history and purchase history. Other information associated with customers 135 may be included in the product records 650.

Computer memories 540, 640 may be the same memory, and may reside on the retailer server 210. In alternative embodiments the memories 540, 640 may reside on other servers accessible via the network 205. The databases 215, 216 only need to be accessible by the retailer server.

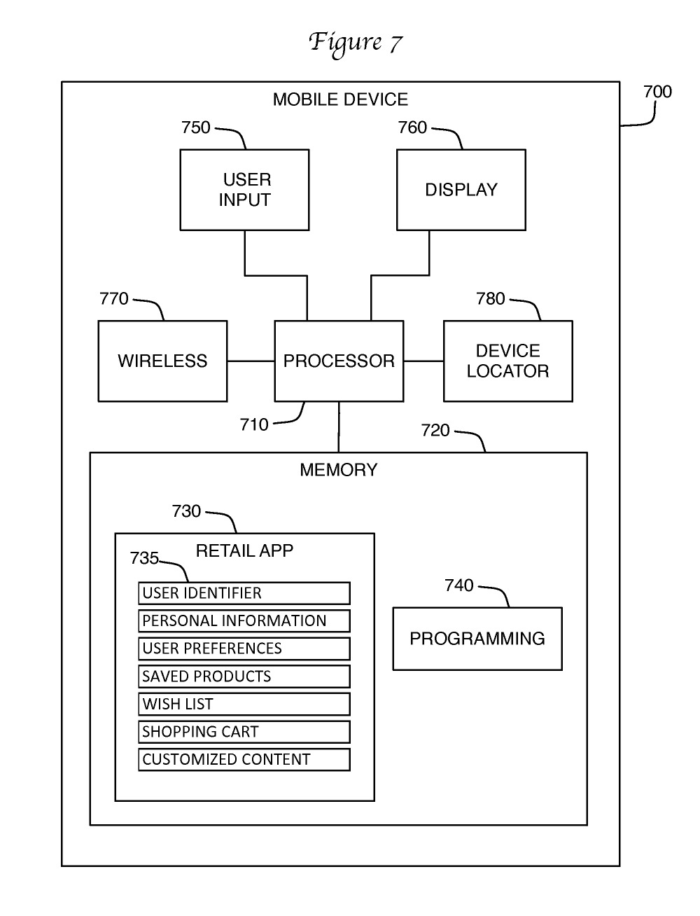

FIG. 7 shows a more detailed schematic of a mobile device 700. The device 700 is a generalized schematic of either of the devices 136, 139. The device 700 includes a processor 710, a device locator 780, a display screen 760, and wireless interface 770. The wireless interface 770 may communicate via one or more wireless protocols, such as Wi-Fi, cellular data transfer, Bluetooth, infrared, radio frequency, near-field communication (NFC) or other wireless protocols. One or more data input interfaces 750 allow the device user to interact with the device. The input may be a keyboard, key pad, capacitive or other touchscreen, voice input control, or another similar input interface allowing the user to input commands.

A retail app 730 and programming logic 740 reside on a memory 720 of device 700. The app 730 allows a user to perform searches of product database 216, select products for viewing on display 131, as well as other functions. In a preferred embodiment, the retail app stores information 735 about the mobile device user. The information 735 includes a user identifier (“user ID”) that uniquely identifies a customer 135. The information 735 also includes personal information such as name and address, user preferences such as favorite store locations and product preferences, saved products for later viewing, a product wish list, a shopping cart, and content customized for the user of device 700.

If the mobile device 700 is a customer device 136, the information 735 can be stored on memory 720. If the device 700 is a clerk device 139, the information 735 could be retrieved from user database 215 and not stored on memory 720.

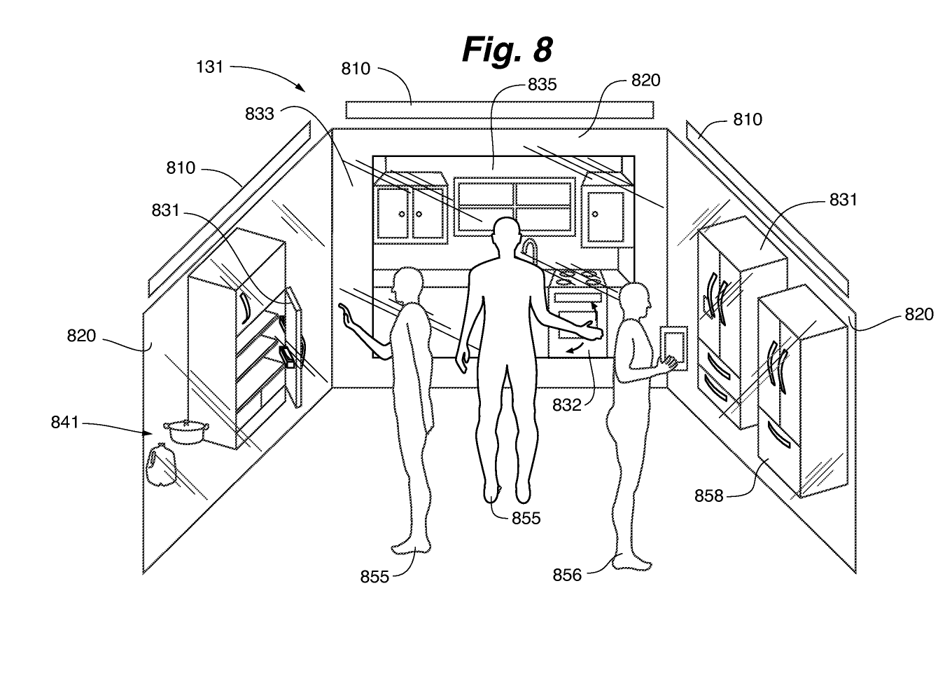

FIG. 8 shows an exemplary embodiment of display 131 of FIG. 1. In FIG. 8, the display 131 comprises one or more display screens 820 and one or more sensors 810. The sensors 810 may include motion sensors, 3D depth sensors, heat sensors, light sensors, pressure sensors, audio microphones, etc. Such sensors will be known and understood by one of ordinary skill in the art. Although sensors 810 are depicted in FIG. 8 as being overhead sensors, the sensors 810 could be placed in multiple locations around display 131. Sensors 810 could also be placed at various heights above the floor, or could be placed in the floor.

In a first section of screen 820 in FIG. 8, a customer 855 interacts with a 3D rendered product image 831 using natural motion gestures to manipulate the image 831. Interactions with product image 831 may use an animation simulating actual use of product 831. For example, by using natural gestures the customer 855 could command the display to perform animations such as opening and closing doors, pulling out drawers, turning switches and knobs, rearranging shelving, etc. Other gestures could include manipulating 3D rendered images of objects 841 and placing them on the product image 831. Other gestures may allow the user to manipulate the image 831 on the display 820 to virtually rotate the product, enlarge or shrink the image 831, etc.

In one embodiment a single image 831 may have multiple manipulation modes, such as rotation mode and animation mode. In this embodiment a customer 855 may be able to switch between rotation mode and animation mode and use a single type of gesture to represent a different image manipulation in each mode. For example, in rotation mode, moving a hand horizontally may cause the image to rotate, and in animation mode, moving the hand horizontally may cause an animation of a door opening or closing.

In a second section of screen 820, a customer 855 may interact with 3D rendered product images overlaying an image of a room. For example, the screen 820 could display a background photo image 835 of a kitchen. In one embodiment the customer 855 may be able to take a high-resolution digital photograph of the customer 855's own kitchen and send the digital photo to the display screen 820. The digital photograph may be stored on a customer's mobile device and sent to the display 131 via a wireless connection. A 3D rendered product image 832 could be manipulated by adjusting the size and orientation of the image 832 to fit into the photograph 835. In this way the customer 855 could simulate placing different products such as a dishwasher 832 or cabinets 833 into the customer's own kitchen. This virtual interior design could be extended to other types of products. For example, for a furniture retailer, the customer 855 could arrange 3D rendered images of furniture over a digital photograph of the customer 855's living room.

In a large-screen or multiple-screen display 131 as in FIG. 8, the system preferably can distinguish between different customers 855. In a preferred embodiment, the display 131 supports passing motion control of a 3D rendered image between multiple individuals 855-856. In one embodiment of multi-user interaction with display 131, the sensors 810 track a customer's head or face to determine where the customer 855 is looking. In this case, the direction of the customer's gaze may become part of the raw data that is interpreted as a gesture. For example, a single hand movement by customer 855 could be interpreted by the controller 240 differently based on whether the customer 855 was looking to the left side of the screen 820 or the right side of the screen 820. This type of gaze-dependent interactive control of 3D rendered product images on display 131 is also useful if the sensors 810 allow for voice control. A single audio voice cue such as “open the door” combined with the customer 855's gaze direction would be received by the controller 240 and used to manipulate only the part of the 3D rendered image that was within the customer 855's gaze direction.

In one embodiment, an individual, for example a store clerk 856, has a wireless electronic mobile device 858 to interact with the display 131. The device 858 may be able to manipulate any of the images 831, 835, 841 on display screen 820. If a plurality of interactive product displays 131 are located at a single location as in FIG. 8, the system may allow a single mobile device 858 to be associated with one particular display screen 820 so that multiple mobile devices can be used in the store 101. The mobile device 858 may be associated with the interactive display 131 by establishing a wireless connection between the mobile device and the interactive display 131. The connection could be a Wi-Fi connection, a Bluetooth connection, a cellular data connection, or other type of wireless connection. The display 131 may identify that the particular mobile device 858 is in front of the display 131 by receiving location information from a geographic locator within device 858, which may indicate that the mobile device 858 is physically closest to a particular display or portion of display 131.

Data from sensors 810 can be used to facilitate customer interaction with the display screen 820. For example, for a particular individual 856 using the mobile device 858, the sensors 810 may identify the customer 856's gaze direction or other physical gestures, allowing the customer 858 to interact using both the mobile device 858 and the user's physical gestures such as arm movements, hand movements, etc. The sensors 810 may recognize that the customer 856 is turned in a particular orientation with respect to the screen, and provide gesture and mobile device interaction with only the part of the display screen 820 that the user is oriented toward at the time a gesture is performed.

It is contemplated that other information could be displayed on the screen 820. For example, product descriptions, product reviews, user information, product physical location information, and other such information could be displayed on the screen 820 to help the customer view, locate, and purchase products for sale.

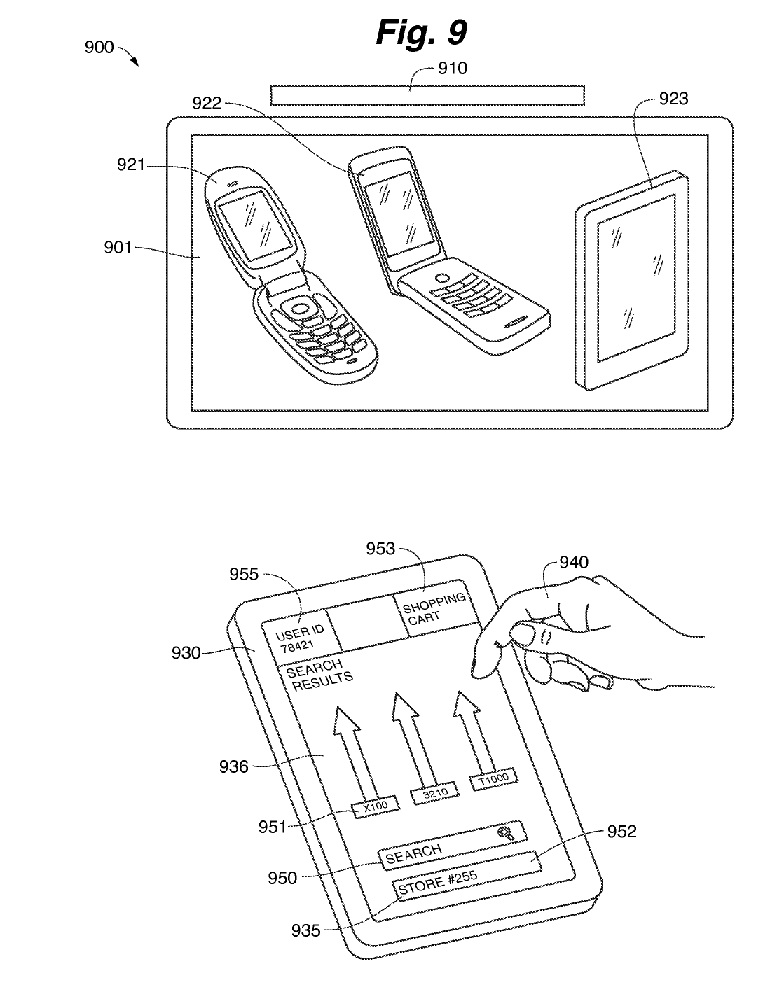

FIG. 9 shows a virtual interactive retail display system 900 which includes a display screen 901, one or more sensors 910, and a mobile device 930. In a preferred embodiment, the device 930 is a touchscreen-operated device such as a tablet computer. In alternative embodiments, device 930 could be a smartphone, a laptop computer, or a dedicated stand-alone kiosk.

The embodiment of FIG. 9 shows a side-by-side display mode in which a customer 940 can simultaneously view a plurality of 3D rendered images 921, 922, and 923 of retail products for sale. The side-by-side comparison allows the customer 940 to compare features of multiple similar products. In addition to 3D rendered images, the display screen could also show a list of specifications for each product 921-923.

In the embodiment of FIG. 9, the device 930 has a retail app 935 that allows a user 940 to interact with 3D rendered images 921-923 on display screen 901. The retail app 935 has a search function 950 allowing the user 940 to search product database 216 for products to display on the screen 901. The app 935 may also allow the user 940 to input a geographic location 952 of the mobile device 930, for example an address, a city, or an identifier specifying a particular retail store location. The identified location 952 can help the customer 940 determine whether a particular product is available as a physical product for viewing within a retail store, or whether the product can only be viewed on the virtual interactive display 900.

The app 935 preferably has the ability to store a user ID 955 representing a particular self-identified customer 940. By self-identifying in the app 935, the user 940 can save searched items and make purchases through a shopping cart feature 953. The user ID 955 may be used during a purchase transaction. The unique user ID 955 would be associated with a product identifier for a product that the customer 940 wishes to purchase. A payment method, such as a credit card number or store account, may be associated with the unique customer ID.

A user can enter product search terms in search box 950. The app 935 sends the search term to query product database 216. The app 935 receives a search result 951 including one or more products matching the search term. The user 940 can select one or more products from the search results 951 to view as images 921-923 on display 901.

If device 930 is a touchscreen device, the user 940 can use touch gestures on the device to select products 921-923 to view on the display 901. One such gesture is a “swipe” gesture 959 in which the user 940 makes finger contact with the touchscreen 936 and glides the finger along the surface of the touchscreen 936 toward the display screen 901. The swipe gesture 959 is interpreted as a command to display the selected search result 951 on the display screen 901.

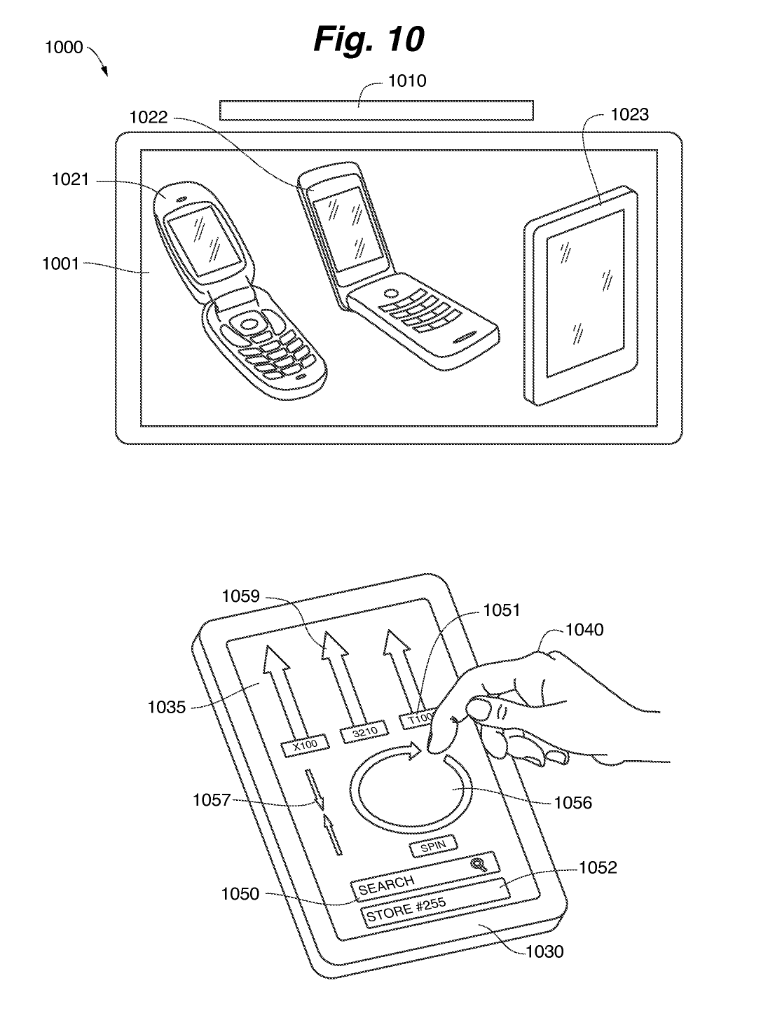

FIG. 10 shows an alternative embodiment of a virtual interactive retail display system 1000 having a display screen 1001, one or more sensors 1010, and a mobile device 1030 with a touchscreen 1057. Display screen 1001 allows a customer 1040 to view side-by-side 3D rendered images 1021, 1022, and 1023 of retail products for sale.

A software program application 1035 on device 1030 allows a customer 1040 to search products from search box 1050, indicate a location 1052 for the device 1030, and receive search results 1051. The app 1035 could also provide customer self-identification and a shopping cart feature. In the embodiment of FIG. 10, the user 1040 can manipulate the 3D rendered images 1021-1023 on the display screen 1001 by using gestures 1056. In a preferred embodiment the app 1035 includes a gesture toggle function that allows a single gesture 1056 to control multiple interactions on the display screen 1001. A single gesture could then be re-used. For example, the app 1035 could allow a customer to toggle between rotate mode and animation mode. For example, in rotate mode the user 1040 may glide a finger in a circular pattern on the touchscreen 1057 to virtually rotate the 3D images 1021-1023 on the screen 1001 and view the products from all angles. The images 1021-1023 may synchronously rotate, or the images 1021-1023 may be rotated individually. If the user toggles to animation mode, the same circular gesture 1056 could cause an animation of the cellular phone images 1021, 1022 to open and close. Other gestures on the touchscreen 1057 could simulate image manipulation of the images 1021-1023 in other modes that will be apparent to one of ordinary skill in the art.

In an alternative embodiment, the virtual interactive display 1000 may be used with two mobile devices 1030 simultaneously. In this embodiment it will be advantageous to allow independent control of parts of the display screen 1001 by each mobile device 1030. This could be accomplished by initiating a first wireless connection between a first mobile device and the display 1000, then initiating a second wireless connection between a second mobile device and the display 1000. The display 1000 differentiates between the first and second mobile devices. Each device can perform a search of the database and request to view product images on the display screen 1001. In one embodiment each mobile device may be able to control only an image that was requested by that particular mobile device. In this way the product images 1021-1023 can be displayed side-by-side while still allowing the mobile devices to operate independently.

In one embodiment, the virtual interactive display system 900 provides an improved shopping interaction between a customer 135 and a store clerk 137. The clerk 137 is preferably provided with the mobile device 930 as a dedicated customer service device having the application software 935 for searching, selecting, and interacting with virtual interactive images of products for sale. Clerk 137 consults customer 135 to determine which products the customer 135 may want to view and purchase. The clerk 137 can first discuss available products with the customer 135, then search for products on retail app 935 of mobile device 930. The clerk 137 can also direct the customer 135 to view physical retail products 115 if the products are physically available in the store 101. This embodiment creates a more personalized shopping experience for customer 135.

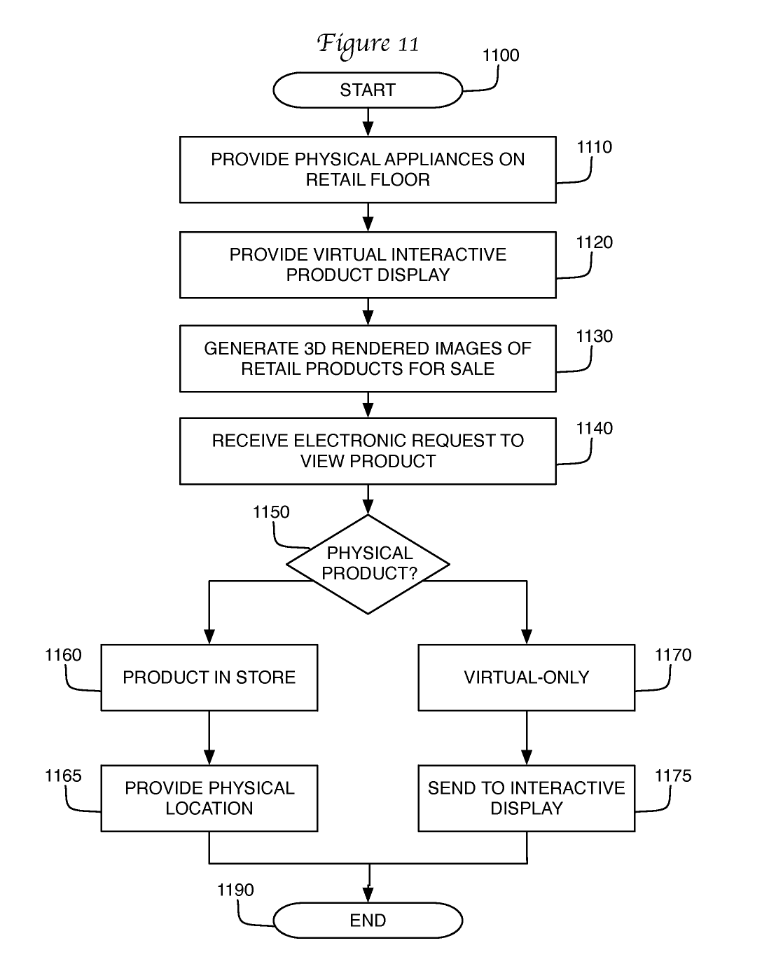

FIGS. 11-17 and 19 are flow charts showing methods to be used with various embodiments of the present disclosure. The embodiments of the methods disclosed in FIGS. 11-17 and 19 herein are not to be limited to the exact sequence described. Although the methods presented in the flow charts of FIGS. 11-17 and 19 are depicted as a series of steps, the steps may be performed in any order, and in any combination. The methods could be performed with more or fewer steps. One or more steps in any of the methods of FIGS. 11-17 and 19 could be combined with steps of methods shown in other of FIGS. 11-17 and 19.

FIG. 11 is a flow chart demonstrating a method for presenting products to retail customers in a physical retail store. The method may be implemented by a retailer selling consumer appliances within a traditional brick and mortar physical store as shown in FIGS. 1-10

In step 1110, physical products 115 are provided on a floor-space 110. In step 1120, a virtual interactive product display 131 is provided in floor-space 130. In step 1130, 3D rendered images of products for sale are generated. The 3D rendered images may be stored on database 216 of FIG. 2 to be accessed later.

In step 1140 an electronic request to view a product is received. The electronic request may be in the form of a product search request initiated within an app 263 of customer device 136 or app 291 of clerk device 139. In step 1150 the system determines whether the requested product is available to view as a physical product 115 in retail store 101. If a floor model of the product is found to be available in step 1160, the system returns a response in step 1165 indicating the physical location of the floor model 115. In one embodiment the response in step 1165 may be provided as an electronic image of a map indicating the geographic location of retail store 101. The response 1165 may also include an address for store 101. Alternatively, if the location devices 261, 293 indicate that the device 136, 139 is inside of a physical store location, step 1165 may return a more specific location, such as an aisle number for the product or a store map.

If it is determined in step 1170 that a physical product is not available for viewing, a response is provided indicating that the product is only available for viewing on the virtual display 131. In step 1175 the 3D rendered image of the product is sent to the interactive display 131 to be viewed by the customer 135 on the display screen 242. The method ends at step 1190.

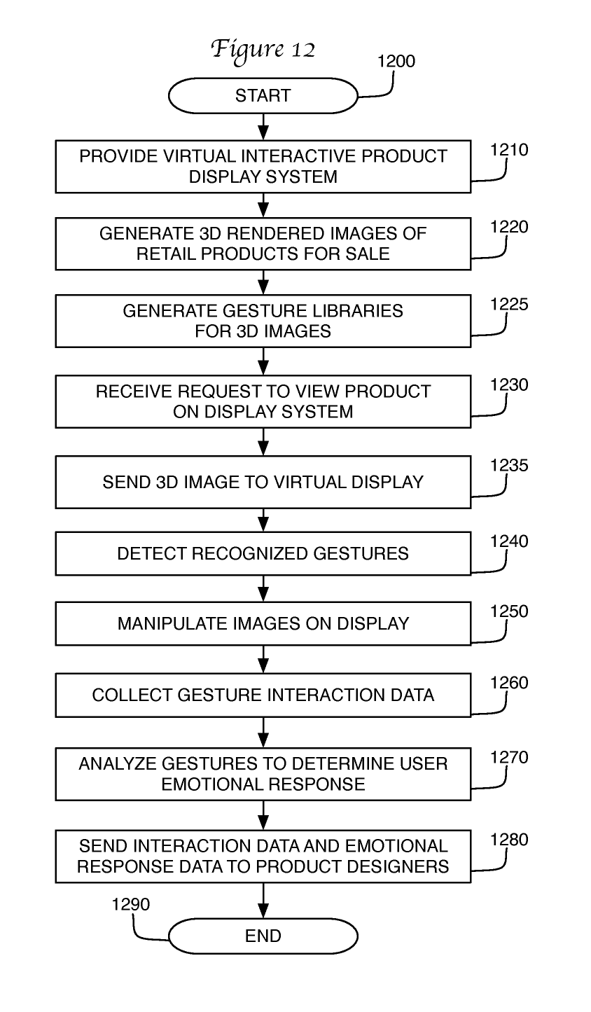

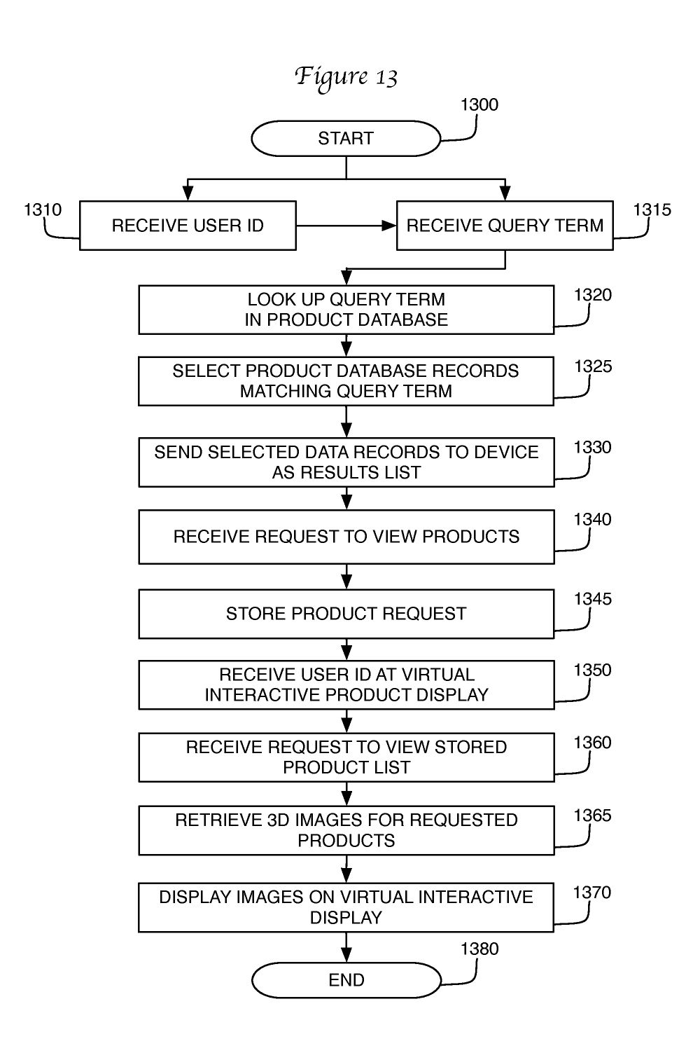

In one embodiment of the virtual interactive product display, a method 1200 shown in FIG. 12 can be used to analyze a customer's emotional reaction to 3D images on the display screen. The method may determine the customer's emotional response to a particular part of the image that the customer is interacting with. Motion sensors or video cameras may record a customer's skeletal joint movement or facial expressions, and use that information to extrapolate how the customer felt about the particular feature of the product. The sensors may detect anatomical parameters such as a customer's gaze, posture, facial expression, skeletal joint movements, and relative body position. This information can be provided to a product manufacturer as aggregated information. The manufacturer may use the emotion information to design future products.

The algorithms may be supervised or unsupervised machine learning algorithms; may use logistic regression or neural networks; and will be used to classify customer response to image manipulation on the display screen.

Computer analysis programming, including machine learning programming, can use the sensor data to determine a customer's emotions. For example, a change in the joint position of a customer's shoulders may indicate that the customer is slouching, which may be interpreted as a negative reaction to a particular product. The particular part of the product image to which the customer reacts negatively can be determined either by identifying where the customer's gaze is pointed, or by determining which part of the 3D image the user was interacting with while the customer slouched.

Facial expression revealing a customer's emotions could also be detected by a video camera and associated with the part of the image that the customer was interacting with. Both facial expression and joint movement could be analyzed together to verify that the interpretation of the customer emotion is accurate.

Skeletal joint information and facial feature information can be used to generally predict anonymous demographic data for customers interacting with the virtual product display. The demographic data, such as gender and age, can be associated with the customer emotional reaction to further analyze customer response to products. For example, gesture interactions with 3D images may produce different emotional responses in children than in adults.

A heat map of customer emotional reaction may be created from an aggregation of the emotional reaction of many different customers to a single product image. Such a heat map may be provided to the product manufacturer to help the manufacturer improve future products. The heat map could also be utilized to determine the types of gesture interactions that customers prefer to use with the 3D rendered images. This information would allow the virtual interactive display to present the most pleasing user interaction experience with the display.

FIG. 12 shows the method 1200 for determining customer emotional reaction to 3D rendered images of products for sale. In step 1210, a virtual interactive product display system is provided. The interactive display system may be systems described in FIGS. 1-10. The method 1200 may be implemented in a physical retail store 101 of FIG. 1, but the method 1200 could be adapted for other locations, such as inside a customer's home. In that case, the virtual interactive display could comprise a television, a converter having access to a data network 205 (e.g., a streaming media player or video game console), and one or more video cameras, motion sensors, or other natural-gesture input devices enabling interaction with 3D rendered images of products for sale.

In step 1220, 3D rendered images of retail products for sale are generated. In a preferred embodiment each image is generated in advance and stored in a products database 216 along with data records 550 related to the product represented by the 3D image. The data records 550 may include a product ID, product name, description, manufacturer, etc. In step 1225 gesture libraries are generated. Images within the database 216 may be associated with multiple types of gestures, and not all gestures will be associated with all images. For example, a “turn knob” gesture would likely be associated with an image of an oven, but not with an image of a refrigerator.

In step 1230, a request to view a 3D product image on display 131 is received. In response to the request, in step 1235 the 3D image of the product stored in database 216 is sent to the display 131. In step 1240 gestures are recognized by sensors 244, 246 at the display 131. The gestures are interpreted by controller computer 240 as commands to manipulate the 3D images on the display screen 242. In step 1250 the 3D images are manipulated on the display screen 242 in response to receiving the gestures recognized in step 1240. In step 1260 the gesture interaction data of step 1240 is collected. This could be accomplished by creating a heat map of a customer 135's interaction with display 131. Gesture interaction data may include raw sensor data, but in a preferred embodiment the raw data is translated into gesture data. Gesture data may include information about the user's posture and facial expressions while interacting with 3D images. The gesture interaction data may be stored on a data analysis server 220 in data records 425.

In step 1270, the gesture interaction data is analyzed to determine user emotional response to the 3D rendered images. The gesture interaction data may include anatomical parameters in addition to the gestures used by a customer to manipulate the images. The gesture data captured in step 1260 is associated with the specific portion of the 3D image that the customer 135 was interacting with when exhibiting the emotional response. For example, the customer 135 may have interacted with a particular 3D image animation simulating a door opening, turning knobs, opening drawers, placing virtual objects inside of the 3D image, etc. These actions are combined with the emotional response of the customer 135 at the time. In this way it can be determined how a customer 135 felt about a particular feature of a product.

The emotional analysis could be performed continuously as the gesture interaction data is received, however, the gesture sensors will generally collect an extremely large amount of information. Because of the large amount of data, the system may store the gesture interaction data in data records 425 on a data analysis server 220 and process the emotional analysis at a later time.

In step 1280, the analyzed emotional response data is provided to a product designer. For example, the data may be sent to a manufacturer 290 of the product. Anonymous gesture analytic data is preferably aggregated from many different customers 135. The manufacturer can use the emotional response information to determine which product features are liked and disliked by consumers, and therefore improve product design to make future products more user-friendly. The method ends at step 1290.

In one embodiment the emotional response information could be combined with customer-identifying information. This information could be used to determine whether the identified customer liked or disliked a product. The system could then recommend other products that the customer might like. This embodiment would prevent the system from recommending products that the customer is not interested in.

The method of FIG. 12 could also be performed in a physical retail store 101 using physical products 115. In this alternative embodiment, the physical product 115 that the customer 135 interacts with may be identified by a visual imaging camera 244. This alternative embodiment is useful in a situation where the physical products 115 are stationary items, such as large appliances or furniture. Each physical product 115 has a known location in the store. One or more sensors 244, 246 could identify the product 115 that the customer 135 was interacting with, and detect the customer 135's anatomical parameters such as skeletal joint movement or facial expression. In this alternative method, a customer 135 would be detected by the sensors 244, 246; the sensors 244, 246 would detect recognized interactions from the customer 135; product interaction data would be collected; and the interaction data would be aggregated and used to determine the emotions of the customer.

FIG. 13 is a flow chart demonstrating a method 1300 for displaying a plurality of pre-selected products on a virtual interactive display. The method 1300 may be implemented in the system shown in FIGS. 9-10. In step 1310, a user ID is received. In the preferred embodiment, the user ID 955 is input into a retail app 935 on a mobile device 930. The user ID 955 corresponds to a customer 135 having a data record 650 in customer database 215. In an alternative embodiment in which the customer 135 does not self-identify, step 1310 could be skipped. In step 1315 a query term is received. The query may be sent as a search 950 from the retail app 935. In step 1320, the query term is used to search product database 216 for products matching the query. In step 1325 products matching the query term are selected as a query result, and in step 1330 the query results are sent to device 930 as search results 951.

In one embodiment, in step 1340 a request to view products is received, and the request is stored in step 1345. This embodiment is useful in a situation in which a customer 135 is not in retail store 101. The customer 135 would perform a search for products that the customer 135 would like to view. Later when the customer 135 is inside the retail store 101, the customer can view the selected products. Steps 1340 and 1345 could be omitted if the customer 135 is in front of the display 901.

In step 1350, a user ID 955 may be received at the virtual interactive product display. This step could be omitted if the customer 135 wishes to remain anonymous.

In step 1360, a request is received to view products at the virtual interactive display screen 901. The request may be initiated in a number of different ways. In one embodiment the request could be received as a “swipe to screen” gesture command 959. In an alternative embodiment the system could detect the physical presence of mobile device 930 near display screen 901, and automatically send the selected product image to the screen 901. This could be accomplished by detecting the proximity of device 930 via Bluetooth, RFID, NFC, etc. A handshake protocol between the mobile device 930 and the display system 900 would be initiated, after which the product selection could be automatically sent by the app 935, and the 3D images of products 921-923 would be displayed on screen 901 without further involvement of the customer 135. In yet another embodiment a request could be sent from the mobile device 930 via the Internet.

In step 1365, the requested 3D images are retrieved from product database 216. In step 1370 the 3D images are displayed on virtual interactive product display 901. The customer 135 can then interact with the 3D images via natural gestures as described in FIGS. 8-10. The method endes at step 1380.

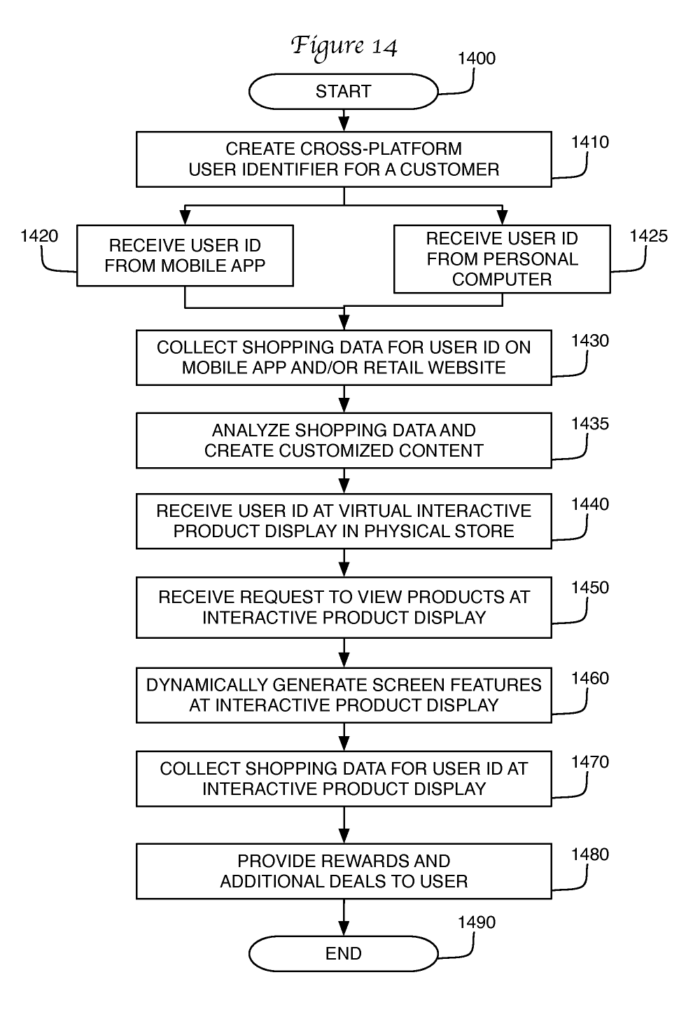

FIG. 14 is a flow chart demonstrating a method for creating customized content and analyzing shopping data for a self-identified customer. In step 1410, a cross-platform user identifier is created for a customer. This could be a unique numerical identifier associated with the customer. In alternative embodiments, the user ID could be a loyalty program account number, a credit card number, a username, an email address, a phone number, or other such information. The user ID must be able to uniquely identify a customer making purchases and shopping across multiple retail platforms, such as mobile, website, and in-store shopping.

Creating the user ID requires at least associating the user ID with an identity of the customer 135, but could also include creating a personal information profile 650 with name, address, phone number, credit card numbers, shopping preferences, and other similar information. The user ID and any other customer information associated with the customer 135 is stored in user information database 215.

In a preferred embodiment the association of the user ID with a particular customer 135 could happen via any one of a number of different channels. For example, the user ID could be created at the customer mobile device 136, the mobile app 935, the personal computer 255, in the physical retail store 101 at POS 150, at the display 131, or during the customer consultation with clerk 137.

In step 1420, the user ID may be received in mobile app 930 as user ID 955. In step 1425, the user ID 955 may be received from personal computer 255 when the customer 125 shops on the retailer's website. One of the steps 1420 and 1425 could be omitted.

In step 1430, shopping data, browsing data, and purchase data are collected for shopping behavior on mobile app 935 or personal computer 255. In step 1435 the shopping data is analyzed and used to create customized content. The customized content could include special sales promotions, loyalty rewards, coupons, product recommendations, and other such content.

In step 1440, the user ID is received at the virtual interactive product display 901. In step 1450 a request to view products is received. The request may be similar to the request in step 1340 of FIG. 13. In step 1460, screen features are dynamically generated at interactive display 1440. For example, the dynamically-generated screen features could include customized product recommendations presented on display 901; a welcome greeting with the customer's name; a list of products that the customer recently viewed; a display showing the number of rewards points that the customer 135 has earned; or a customized graphical user interface “skin” with user-selected colors or patterns. Many other types of customer-personalized screen features are contemplated and will be apparent to one skilled in the art.

In step 1470, shopping behavior data is collected at the interactive product display 901. For example, information about the products viewed, the time that the customer 135 spent viewing a particular product, and a list of the products purchased could be collected. In step 1480, the information collected in step 1470 is used to further provide rewards, deals, and customized content to the customer 135. The method ends at step 1490.

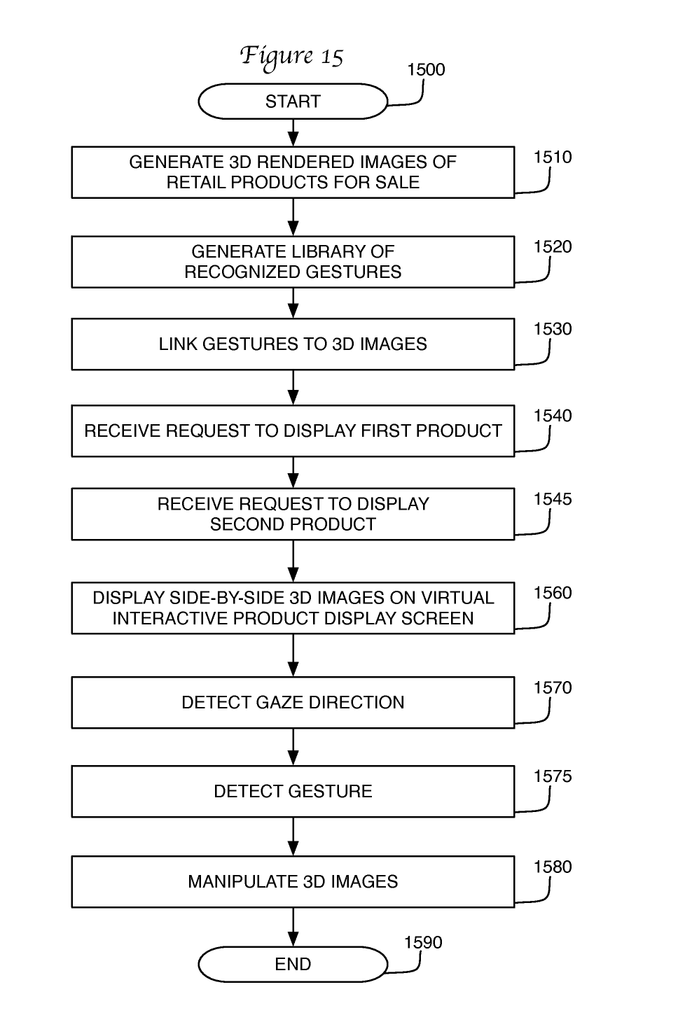

FIG. 15 is a flow chart demonstrating a method for presenting side-by-side product comparisons using a virtual interactive product display 901. In step 1510, 3D rendered images of retail products for sale are generated. Step 1510 may be similar to step 1220 of FIG. 12. In step 1520, a gesture library is generated. Step 1520 may be similar to step 1225 of FIG. 12. In step 1530 the recognized gestures are linked to particular 3D images. In one embodiment the gesture library contains standardized actions for all products in a particular category. For example, in the embodiment of FIG. 9, all of the images 921-932 would be associated with a gesture to produce virtual rotation of the images 921-923, and images 921 and 922 could be associated with a gesture to produce an open/close animation. The open/close gesture would not be associated with image 923 because that feature is unavailable to that particular product.

In one embodiment the gestures may be separated into different manipulation mode categories such as a rotation mode or animation mode. This embodiment allows the system to reuse a single gesture to produce a different kind of image manipulation depending upon the selected mode. In rotation mode, if a customer 135 performs a gesture corresponding to a rotate command, all three of the 3D images 921-923 will rotate synchronously. In an alternative embodiment, the images 921-923 may be manipulated one at a time. In this embodiment the customer 135's gaze direction could be used in combination with a detected gesture to determine which one of the images 921-923 should be manipulated. If the sensors 910 determine that the customer's gaze is directed toward image 921, only the image 921 will be manipulated, and not the images 922-923. In animation mode, the customer 135's gaze direction could be used to determine which animation to perform in response to a particular gesture.

In step 1540 a request to display a first product is received at the display 900. Step 1540 may be similar to step 1360 as described in FIG. 13. In step 1545 a request is received to display a second product. The requests in steps 1540 and 1545 may be received simultaneously, or one at a time.

In step 1560 the 3D rendered images for the requested products are displayed on the interactive display screen 901. In step 1570, the customer 135's gaze direction may be detected. The gaze direction determines which of the images 921-923 is looking at, and preferably which specific feature of the product the customer 135 is looking at. This gaze direction information can be captured by video camera 244 or sensors 246 and used for data analysis to create heat maps to compare the customer 135's interest in particular products when comparing the products side-by-side.

In step 1575 a gesture is detected by the interactive display 900. The gesture may be a physical body movement by the customer 135 which is detected by motion sensors. The gesture could also be a touch gesture 1056 on the touchscreen of mobile device 1030 of FIG. 10. In response to the gesture, one or more of the 3D images 921-923 are manipulated on the display 901.

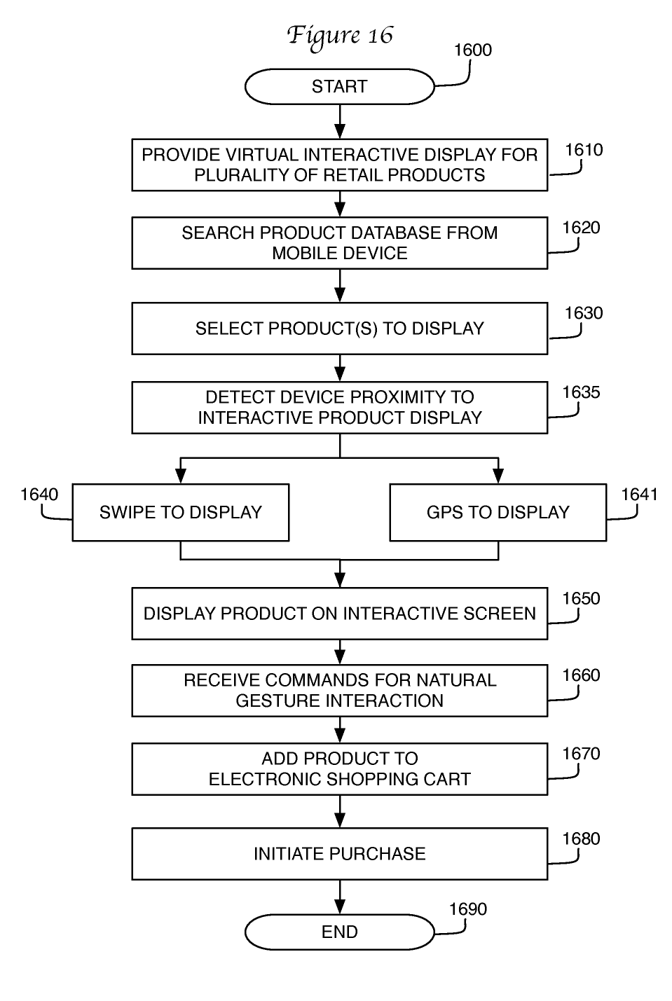

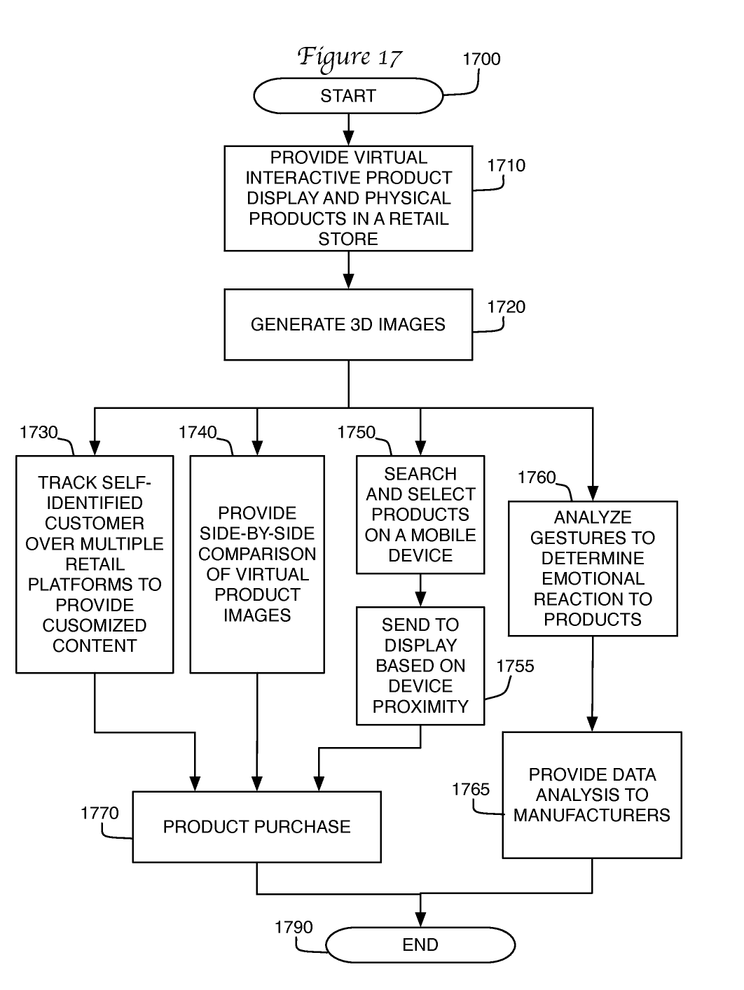

FIG. 16 is a flow chart demonstrating a method 1600 for searching and displaying 3D rendered models of products for sale. In step 1610, a virtual interactive product display 1000 is provided in a retail store. The interactive display 1000 could be provided in a retail store having both physical retail products and the display 1000. In an alternative embodiment the display 1000 could be a stand-alone kiosk without any physical retail products. In step 1620, mobile device 1030 sends a search request to search for products in database 216. In step 1630 the customer chooses one or more products to view on the interactive display 1000. In step 1635 the display 1000 detects the proximity of mobile device 1030 to the display 1000. The proximity may be detected via Wi-Fi, Bluetooth, RFID, NFC, etc. In this case, a handshake protocol between the mobile device 1030 and the display system 1000 would be initiated.

In an alternative embodiment, a GPS device or other geographic locator residing on mobile device 1030 could communicate its location to the display 1000 via the Internet. The display 1000 recognizes based on the geographic coordinates of the device 1030 that the device 1030 is in proximity to the display 1000.

In steps 1640 and 1641 the products selected in step 1630 are sent as a request to view products on the display 1000. In step 1640 the mobile device app 1035 detects a “swipe” gesture touch on the touchscreen 1057 and interprets the touch as a command to send the image of the product to the display screen 1001. Alternatively, in step 1641 the image of the product could be sent automatically to the display screen 1001 in a GPS-to-display function. In this step the location of the device is determined by a device locator such as the device locator 780 in FIG. 7. The locator 780 could either initiate sending the device location to the display 1000, or the display system could send a request to the device for the device to provide its location. Once the location is provided to the display 1000, the selected products will be displayed automatically in response to receiving the location.

In step 1650, the selected products are displayed on the display 1000. In step 1660, gesture sensors 1010 receive commands via natural gesture interaction. The gestures may be physical body, arm, hand, or face movements. The gestures could alternatively be touch gestures 1056 on a touchscreen interface 1057 of a mobile device 1030.

In step 1670, the customer provides a request to add an item shown on the display 1001 to an electronic shopping cart similar to shopping cart 953 of FIG. 9. The request may be made via natural physical gestures received by a motion sensor 1010, or the request could be performed as a touch gesture 1056.

The purchase is initiated in step 1680. Step 1680 may include receiving a gesture from a user, via either gesture sensors 1010 or gestures 1056 on the mobile device 1030. The gestures indicate the user's desire to purchase the product. In one embodiment, the display controller computer receives the gesture indicating the desire to purchase, then sends a request back to the display screen 1001 or the mobile device 1030 requesting that the customer confirm the desire to purchase the product. The customer would then perform another gesture confirming the purchase.

The customer may provide a customer ID during the purchase process in step 1680. In a preferred embodiment the customer ID is a unique ID linked to a payment account for the customer. For example, the customer ID may be linked to a saved credit card number or store account. The system can then automatically process the purchase transaction using the stored payment account.

FIG. 17 is a flow chart demonstrating a combination of methods for a virtual interactive product display. The various steps may be performed independently or in combination. The method may be used with the system and methods shown and described in relation to FIGS. 1-16.

In step 1710, a virtual interactive product display is provided in a physical retail store. In one embodiment, physical products are also provided, however the interactive display could be provided independent of physical products. In step 1720, a plurality of three-dimensional rendered images of products for sale are generated. In one embodiment the images are stored in a product database.

In step 1730, a self-identified customer is tracked over multiple retail platforms, such as Internet, mobile, and in-store. The customer may be provided with a unique customer ID that is stored with customer information in a user information database. In step 1740, a side-by-side product comparison of virtual images is provided. In step 1750, a customer or store clerk may search for products on a mobile device, and use an app on the mobile device to select products to view on the interactive display screen. In step 1755 the selected products are sent to be displayed as 3D images on the virtual interactive display, based on the proximity of the mobile device to the display. After any of steps 1730-1755 are performed, a product purchase may be initiated, either at a POS in a physical retail store; through the display screen of the virtual interactive display; or via a mobile device screen.

In step 1760, gestures received by sensors at the interactive display are aggregated and analyzed to determine customer emotional reaction to products viewed on the interactive display. In one embodiment, gesture sensors may also be provided to track customer emotional reaction to physical retail products in addition to the virtual 3D images of products. In step 1765, the gesture interaction and emotional response data is provided to manufacturers for data analysis and product improvement. The method ends at step 1790.

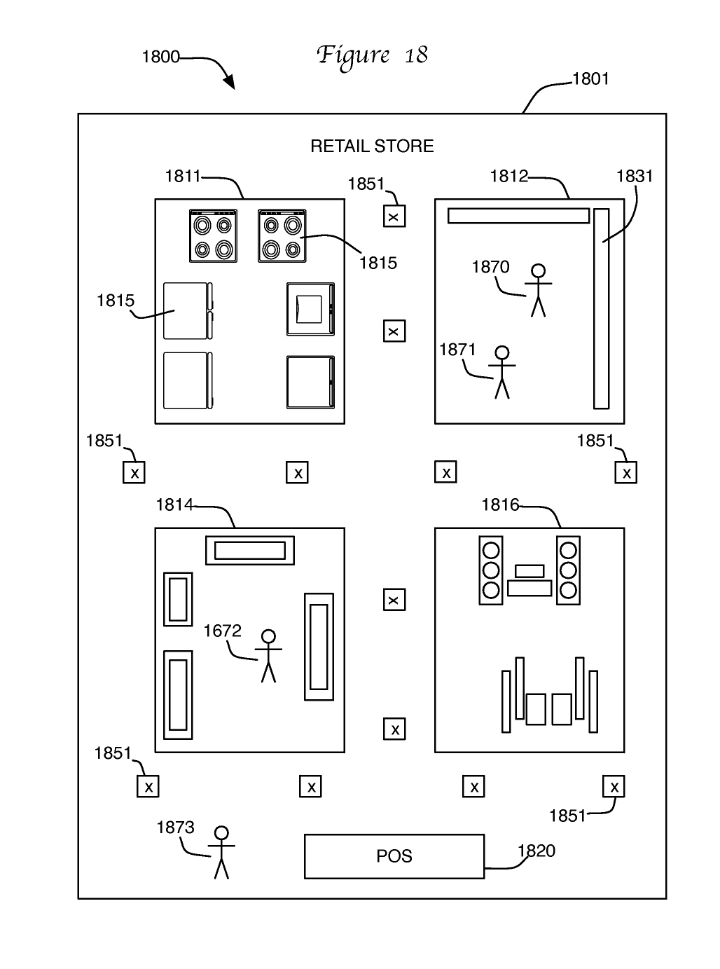

FIG. 18 is a schematic diagram of a customer follow-along system 1800 to track customer interaction with physical retail products 1815 provided on the floor 1811 of a physical retail store 1801. The tracking system 1800 may be provided in addition to a virtual interactive display 1831, but system 1800 could also be provided without the virtual display 1831. The system 1800 is useful to retailers who wish to understand the traffic patterns of customers 1870-1873 around the floor of the retail store 1801.

Within the retail store 1801 are a plurality of sensors 1851. The sensors 1851 are provided to detect customers 1870-1873 as the customers visit different parts of the retail store 1801. Each sensor 1851 is located at a defined location within the physical store, and each sensor 1851 is able to anonymously track the movement of an individual customer 1870 throughout the store 1801. The sensors 1851 each have a localized sensing zone in which the sensor 1851 can detect the presence of a customer 1870. If the customer 1870 moves out of the sensing zone of one sensor 1851, the customer 1870 will enter the sensing zone of another sensor 1851. The system keeps track of the location of customers 1870-1873 across all sensors 1851 within the store 1801. In one embodiment, the sensing zones of all of the sensors 1851 overlap so that customers 1870-1873 can be followed continuously. In an alternative embodiment, the sensing zones for the sensors 1851 may not overlap. In this alternative embodiment the customers 1870-1873 are detected and tracked only intermittently while moving throughout the store 1801.

The system 1800 tracks the individual 1870 based on the physical characteristics of the individual 1870. Video cameras may be utilized, however, motion sensors that track the skeletal joints of individuals can also effectively track anonymous customers. The sensors 1851 could be overhead, or in the floor of the retail store 1801.

A customer 1870 walking through the retail store 1801 is identified by a first sensor 1851, for example a sensor 1851 at a store entrance. The particular customer 1870's identity at that point is anonymous. As the customer 1870 moves about the retail store 1801, the customer 1870 leaves the sensing zone of the first sensor 1851 and enters a second zone of a second sensor 1851. Each sensor 1851 that detects the customer 1870 provides information about the path that the customer 1870 followed throughout the store 1801.

Location data for the customer 1870 is aggregated to determine the path that the customer 1870 took through the store. The system 1800 may also track which physical products 1815 the customer 1870 viewed, and which products were viewed as images on a virtual display 1831. A heat map of store shopping interactions can be provided for a single customer 1870, or for many customers 1870-1873. The heat maps can be strategically used to decide where to place physical products 1815 on the retail floor, and which products should be displayed most prominently for optimal sales.

If the customer 1870 leaves the store 1801 without self-identifying or making a purchase, the tracking data for that customer 1870 may be stored and analyzed as anonymous tracking data. If however the customer 1870 chooses to self-identify at any point in the store 1801, the customer 1870's previous movements around the store can be retroactively associated with the customer 1870. For example, if a customer 1870 enters the store 1801 and is tracked by sensors 1851 within the store, the tracking information is initially anonymous. However, if the customer 1870 chooses to self-identify, for example by entering a customer ID into the display 1831, or providing a loyalty card number when making a purchase at POS 1820, the previously anonymous tracking data can be assigned to that customer ID. Information, including which store the customer 1870 visited and which products the customer 1870 viewed, can be used with the method 1400 to provide deals, rewards, and incentives to the customer 1870 to personalize the customer 1870's retail shopping experience.

In an alternative embodiment, method 1200 of FIG. 12 could be implemented in retail store 1801 for physical retail products 1815. In this embodiment the sensors 1815 would collect interaction data when customers 1870 interact with physical retail products 1815.

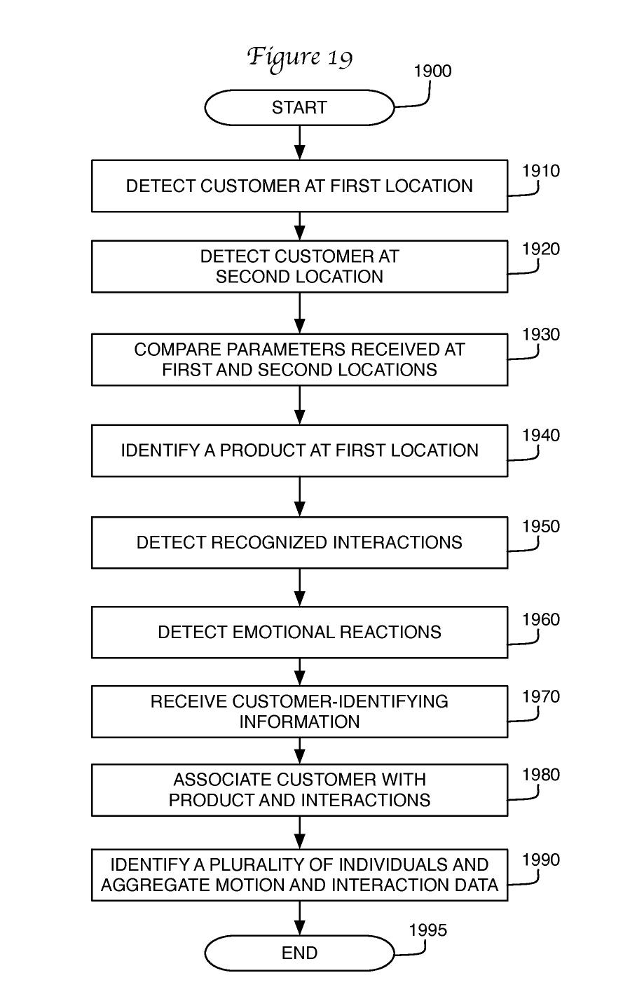

FIG. 19 shows a method 1900 for collecting customer data analytics in a physical retail store. In step 1910, a sensor 1851 detects a customer 1870 at a first location. The sensor 1851 may be a motion sensor, video camera, or other type of sensor that can identify anatomical parameters for a customer 1870. For example, a customer 1870 may be recognized by a facial recognition, or by collecting a set of data related to the relative joint position and size of the customer 1870's skeleton. This information could be anonymous, but the customer 1870 could choose to self-identify. In step 1920, the customer 1870 is detected at a second location. Initially, the customer 1870 is not automatically recognized by the second sensor 1851 as being the same customer 1870. The second sensor 1981 must collect second anatomical parameters for the customer 1870.

The anatomical parameters detected in steps 1910 and 1920 may be received by the sensors 1851 as “snapshots” of customer anatomical parameters. For example, a first sensor 1851 could record an individual's parameters just once, and a second sensor 1851 could record the parameters once. Alternatively, the sensors 1851 could continuously follow customer 1870 as the customer moves between different sensors 1851.

In step 1930, the first and second anatomical parameters are compared at a data analysis server, where a computer determines that the customer was present at both the first location and the second location. In step 1940, a product 1815 is identified at the first location. The product 1815 may be identified by image analysis using a video camera. Alternatively, the product 1815 could be stationary in a predetermined location, in which case the system would know which product 1815 the customer 1870 interacted with based on the known location of the product 1815 and the customer 1870.

In step 1950, the gesture sensors 1851 detect recognized interactions between the customer 1870 and a product 1815 at a given location. This information could be as simple as recording that the customer 1870 inspected a product 1815 for a particular amount of time. The information collected could also be more detailed. For example, the sensors 1851 could determine that the customer sat down on a couch or opened the doors of a model refrigerator.

In step 1960, the customer's emotional reactions to the interaction with the product 1815 may be detected, as in the method of FIG. 12.

In step 1970, if the customer 1870 chooses, the customer 1870 can provide personally-identifying information. For example, the customer could log on to a mobile device within the store and send the device's location information to the retailer's computers. The customer 1870 could also log on to a dedicated kiosk, or provide personally-identifying information at a virtual interactive product display 1831. In one embodiment, if the customer chooses to purchase a product 1815 at a POS 1820, the customer 1870 may be identified based on purchase information, such as a credit card number or loyalty rewards number.

In step 1980, the personally-identifying customer information is associated with the products 1815 with which the customer 1870 interacted, and the particular recognized interactions between the customer 1870 and product 1815.

In step 1990, the system repeats steps 1910-1980 for a plurality of individuals within the retail store, and aggregates the interaction data for all individuals in the store. The interaction data may include sensor data showing where and when customers moved throughout the store, or which products 1815 the customers were most likely to view or interact with. The information could be information about the number of individuals at a particular location; information about individuals interacting with a virtual display 1831, information about interactions with particular products 1815, or information about interactions between identified store clerks and identified customers 1870-1873. The method ends at step 1995.

Other implementations of the disclosed virtual interactive display system are contemplated. For example, a virtual interactive display could be provided as a stand-alone kiosk with no physical products available. In that case, a customer would only be able to view 3D rendered images of products for sale. Customers could search and browse products on the customer's own mobile device such as a smartphone or tablet computer, then swipe the selected products onto the display. The customer could self-identify and purchase products directly at the kiosk.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for collecting data analytics in a physical retail store having a floor and products displayed at different locations on the floor of the physical retail store, the method comprising:
a) providing a plurality of sensors within the physical retail store, each sensor being located at a defined location within the physical store, and wherein each sensor is able to track movement of an individual within the defined location for that sensor;
b) selecting a first individual to track using a first sensor at a first location when the first individual is within the first location;
c) monitoring movement of the first individual across multiple sensors so as to track the movement of the first individual across multiple locations within the physical retail store;
d) identifying a particular location where the first individual stopped movement within the physical retail store;
e) identifying particular products associated with the particular location within the physical retail store;
f) associating personally-identifying information with the first individual; and
g) associating the personally-identifying information with the particular products within a computerized customer database.

2. The method of claim 1, wherein the personally-identifying information is associated with the first individual after the particular products are identified in step e).

3. The method of claim 1, wherein monitoring the movement of the first individual in step c) is performed by:
i) (h) receiving, from the first sensor, a first anatomical parameter of the first individual at the first location;
b) (i) receiving, from a second sensor, a second anatomical parameter of the first individual at a second location; and
c) (j) comparing the first and second anatomical parameters to determine that the first and second parameters represent a single individual moving from the first location to the second location.

4. The method of claim 1, wherein monitoring movement of the first individual in step c) is performed by:
a) (h) continuously detecting, by the first sensor, that the first individual is within the first location;
b) (i) continuously detecting, by a second sensor, that the first individual is within a second defined location for the second sensor; and
c) (j) comparing anatomical parameters measured by the first and second sensors to determine that the parameter measurements represent the first individual moving from the first location to the second location.

5. The method of claim 1, wherein the sensors are embedded within the floor of the physical retail store and the sensors sense movement of individuals on the floor.

6. The method of claim 1, wherein the sensors are mounted above the floor to track movement of individuals walking on the floor.

7. The method of claim 6, wherein the sensors are selected from a set comprising: motion sensors, visual imaging cameras, and heat sensors.

8. The method of claim 7, wherein the sensors are visual imaging cameras, and further wherein particular products are identified in step e) by evaluating the visual images of the first individual at the particular location to identify the particular products being examined by the first individual.

9. The method of claim 8, wherein the visual imaging cameras identify an emotion of the first individual while examining the particular products, and further wherein the emotion is associated with the particular products and the personally-identifying information within the computerized database.

10. The method of claim 1, wherein the personally-identifying information is associated with the first individual when the first individual identifies themselves during a purchase transaction at a point of sale terminal.

11. The method of claim 1, wherein the personally-identifying information is associated with the first individual through user self-identification at a computer-automated terminal within the physical retail store.

12. The method of claim 1, further comprising using the identified particular products for the first individual in the computerized customer database at a later time to customize interaction between the first individual and an electronic commerce web site.

13. The method of claim 1, wherein the sensors create a map of all movement of the first individual within the physical retail store.

14. A tracking system in a physical retail store comprising:
a) a plurality of sensors within the physical retail store, each sensor being located at a defined location within the physical retail store, wherein each sensor is able to track movement of an individual within the defined location for that sensor;
b) a computer system receiving input from the plurality of sensors, the computer system containing a processor that has been specially programmed to:
i) identify a first individual across multiple sensors so as to track movement of the first individual across multiple locations within the physical retail store,
ii) identify a particular location where the first individual examined a particular product within the physical retail store, and
iii) store the tracked movement of the first individual and the particular product in a computerized customer database; and
c) a means for associating the tracked movement and the particular product with personally-identifying information for the first individual within the computerized customer database.

15. The tracking system of claim 14, wherein the sensors comprise visual imaging sensors that utilize facial analysis to identify the first individual at the particular location.

16. The tracking system of claim 14, wherein the means for associating the tracked movement and the particular product with personally-identifying information for the first individual is selected from a set comprising a point of sale terminal, a computerized kiosk, a gesture driven product display, a mobile device operated by a sales clerk, and a customer mobile device.

17. The tracking system of claim 14, wherein the computer system is further programmed to:
a) iv) receive a first anatomical parameter from a first sensor at a first location,
b) v) receive a second anatomical parameter from a second sensor at a second location, and
c) vi) compare the first and second anatomical parameters to determine that the first and second anatomical parameters represent a single individual that moved from the first location to the second location.

18. The system of claim 17, wherein the first and second anatomical parameters are characteristic skeletal features.

19. The system of claim 17, wherein the first and second anatomical parameters are a facial features.

20. The system of claim 14, wherein the sensors comprise motion sensors that continuously detect the first individual as the first individual moves between the multiple locations in the store.

21. The system of claim 14, wherein the computer system processor is further programmed to identify a plurality of individuals within the store and provide an aggregation of collected sensor data for the plurality of individuals at a delimited location within the store during a given time interval.

22. The system of claim 21, wherein the aggregated sensor data is selected from a set comprising: a total count of individuals at the delimited location, a count of individuals interacting with products at the delimited location, a count of individuals interacting with a virtual interactive product display at the delimited location, and individuals interacting with store clerks at the delimited location.
